(19) United States
(12) Patent Application Publication
(10) Pub. No.: US 2008/0024846 A1
(43) Pub. Date: Jan. 31, 2008

(54) Multi-layer body with micro-optical means

(75) Inventors: Wayne Robert Tompkin, Baden (CH); Andreas Schilling, Hagendorn (CH); Achim Hansen, Zug (CH); Stephane Bolognini, Lausanne (CH); Vincent Moreau, Lausanne (CH)

Correspondence Address: HOFFMANN & BARON, LLP, 6900 JERICHO TURNPIKE, SYOSSET, NY, 11791, US

(73) Assignee: OVD Kinegram AG and KBA-GIORI S.A.

(21) Appl. No.: 11/827,453

(22) Filed: Jul. 12, 2007

(30) Foreign Application Priority Data
Jul. 13, 2006 (DE) 102006032660.1-45

(51) Int. Cl. G03H 1/02; B41M 1/10; G02B 27/42

(52) U.S. Cl. 359/2; 101/170; 359/558

(57) ABSTRACT

Described is a process for the production of a multi-layer body comprising a first layer which is formed from micro-optical structures and which at least partially covers over one or more further layers having image regions and/or effect regions which produce an optical effect, wherein the micro-optical structures are arranged in register relationship with the image regions and/or effect regions. The micro-optical structures (6a, 6b) as well as the image regions and/or effect regions are applied by means of intaglio printing. There are also described a multi-layer body produced with that process and a security document having that multi-layer body.

The invention concerns a process for the production of a multi-layer body having micro-optical structures, a multi-layer body produced with the process and a security document having said multi-layer body.

Numerous processes are known for enhancing the forgery-proof nature of security documents, for example banknotes or visas.

EP 0 429 782 A1 provides an arrangement for improving the forgery-proof nature of banknotes, which provides an OVD film which is applied to the banknote and which is macroscopically shaped, for example by intaglio printing. In that procedure, a macroprofile which has at most 10 lines per millimeter is transferred. The macroprofile and the microprofile of the OVD are so matched to each other that, in attempts at forgery, minor deviations can be immediately detected.

WO 02/091041 A1 describes a micro-mirror array which can be transferred on to a paper or plastic material substrate by printing with ink or lacquer. The period of the micro-mirrors is typically between 30 and 60 μm. The micro-mirrors can be used both in a transillumination mode and also in an incident illumination mode. It is possible in that way to form a two-channel tilting image.

Now the object of the present invention is to provide a simple and inexpensive process for the production of a multi-layer body having micro-optical structures which are in register relationship with further security features such as OVDs and pictorial representations, as well as such a multi-layer body.

The object of the invention is attained by a process for the production of a multi-layer body comprising a first layer which is formed from micro-optical structures and which at least partially covers over one or more further layers having image regions and/or effect regions which produce an optical effect, wherein it is provided that the micro-optical structures are applied by means of intaglio printing to the layer under the first layer or are introduced into the first layer.

The object is further attained by a multi-layer body comprising a first layer which is formed from micro-optical structures and which at least partially covers over one or more further layers having image regions and/or effect regions which produce an optical effect, wherein it is provided that the micro-optical structures are applied by means of intaglio printing to the layer under the first layer or are introduced into the first layer.

The object is further attained by a security document having the multi-layer body according to the invention.

The invention provides that micro-optical structures such as for example micro-lens arrays or blaze gratings are applied by means of intaglio printing. The multi-layer body can be both a transfer film which is applied to a security document or it can be the security document itself or a security document with a transfer film.

Because a plurality of micro-optical structures can be applied at the same time with this process, the complication and expenditure for orientation of the micro-optical structures in accurate register relationship is considerably reduced because the only important consideration is for the one or more printing plates to be oriented relative to each other prior to the printing procedure. Thereafter the multi-layer body can be replicated in large numbers.

In addition it is also possible for the micro-optical structures to be applied to the multi-layer body or introduced into the multi-layer body in an endless, repetitive pattern without being in register relationship with further micro-optical structures.

The multi-layer body according to the invention is distinguished in that it is possible to produce micro-optical structures which are not shaped into a film layer. That avoids all problems which can arise when micro-optical structures are transferred into a transfer film in a roll-to-roll process and then have to be transferred on to a security document in register relationship with other features. A further advantage is that a micro-optical structure which is formed from optical elements which are not connected together cannot be removed and transferred without destroying the structure. Arranging the micro-optical structures in register relationship further enhances the forgery-proof nature of the multi-layer body according to the invention. The multi-layer body can involve a particularly strict register relationship because the complication and expenditure in terms of adjusting the individual objects which are matched to each other are only incurred once.

Further advantageous configurations are set forth in the appendant claims.

It can be provided that the micro-optical structures and also the image regions and/or effect regions are applied by means of intaglio printing.

It can further be provided that both the micro-optical structures and also the image regions and/or effect regions are applied in register relationship. The image regions can be for example single-colored or multi-colored images such as alphanumeric characters, logos or the like. The effect regions can be for example OVDs such as a hologram, a KINEGRAM®, blaze grating or the like. The effect regions can also be tactily perceptible effect regions which for example in suitable form make it possible to feel the imprint of the value of a banknote. Tactily perceptible regions can further form protection from abrasion wear and/or soiling for other regions.

Because the micro-optical structures and/or the image regions and/or the effect regions are applied by a printing procedure in register relationship, there is no need for any additional complication or expenditure for aligning or adjusting the manufacturing equipment used for that purpose. Rather, only the intaglio printing plate has to be produced in accurate register relationship or a plurality of intaglio printing plates have to be adjusted in relation to each other.

It is also possible for different printing inks to be provided in different regions of the intaglio printing plate. It can be provided for example that two colored surfaces adjoin a micro-optical structure and all three elements are surrounded by a black ring, wherein inks of different colors and an optical lacquer are transferred simultaneously on to the substrate to which printing is to be applied, during the printing operation. In that way it is possible in a simple fashion for the optical effects determined by the optical properties of the lacquer (for example colored printing, in particular by means of effect pigments) to be provided in register relationship with the micro-optical structures.

The degree of register accuracy achieved with the process according to the invention can be subsequently achieved only at a very high level of complication and expenditure so that the proposed process enjoys a very high level of forgery-proof nature. It is also not possible to provide individual components and to combine them together because individual components, for example in the form of transfer films or the like, do not physically exist. Further advantages are afforded by virtue of the fact that the micro-optical structures and/or the image regions and/or the effect regions can at least partially overlap each other, thereby further enhancing the forgery-proof nature.

It can be provided that an optical lacquer is transferred by means of intaglio printing on to the further layers, to produce the micro-optical structures.

Alternatively it can be provided that a layer formed from the optical layer is applied to the further layers and then the micro-optical structures are shaped in the layer formed from the optical layer, by means of pressing on an intaglio printing plate which is ink-free at least in region-wise manner. It can therefore be provided that the intaglio printing plate is to be used at least in region-wise manner as an embossing die and the intaglio printing plate is to be pressed under high pressure on to the layer formed from the optical lacquer, so that the optical lacquer completely fills up the recesses produced in the surface of the intaglio printing plate and thus the surface profile of the intaglio printing plate is shaped into the lacquer layer. This variant therefore involves printing without a printing ink. Moreover, a large number of lacquers are available for the process according to the invention, for example including colored optical lacquers as well as the entire range of intaglio printing inks for producing the image regions and/or the effect regions.

An advantageous configuration provides that the layer formed from the optical lacquer is transferred on to the further layers by means of a transfer film. The optical lacquer can be for example a photopolymer lacquer whose viscosity can be adjusted by irradiation with UV-light. It will be noted however that the photopolymer lacquer has to be hardened by means of UV-light after application.

An advantageous configuration provides that the intaglio printing plate is heated at least in the ink-free regions.

It can be provided that the intaglio printing plate is heated to between 90° C. and 100° C.

Further configurations are directed to the formation of the multi-layer body according to the invention. As already stated hereinbefore the micro-optical structures of the multi-layer body are formed from hemispherical or pyramid-shaped or prismatic or cylindrical optical elements with a flat base surface, which are transferred on to the multi-layer body by intaglio printing. In that respect those optical elements can be formed for example from an optical lacquer or the like or from a printing ink or from other printable material. The optical elements however can also be formed by embossing by means of the printing plate, that is to say without transfer of material out of the recesses in the intaglio printing plate on to the surface of the multi-layer body.

It can be provided that the micro-optical structures involve a period spacing of between 100 μm and 0.3 μm, preferably a period spacing of between 20 μm and 2 μm.

Advantageously the micro-optical structures can be of a depth of between 50 μm and 1 μm. It can therefore be provided that the optical elements from which the micro-optical structures are formed are of a height of between 50 μm and 1 μm.

With the above-mentioned ranges in respect of the period spacing and the depth of the micro-optical structures, it is possible to implement depth-to-width ratios or aspect ratios in a wide range. It will be noted however that very high aspect ratios can lead to mechanically unstable structures. It will be noted however that such high aspect ratios are not required to produce the micro-optical structures which are known at the present time.

It can further be provided that the micro-optical structure includes concealed information. The concealed information can be readable in an incident light mode and/or in a transillumination mode, as will be described in greater detail hereinafter.

It can be provided that the micro-optical structure is in the form of a computer-generated hologram. The micro-optical structure can also be a grating, in particular a blaze grating, and/or a micro-lens array and/or a hologram and/or a KINEGRAM® or the like. Although periodic structures in the range of a period length of between 5 μm and 0.3 μm are preferred, the structures can however also involve period structures with a period length>5 μm, motheye structures, in particular in the form of sinusoidal cross gratings with a high aspect ratio and/or stochastic structures.

It can be provided that the micro-optical structure has pixels of differing depths, the depth of the pixels encoding the concealed information.

It can further be provided that the concealed information can be read out in the incident illumination mode and/or in the transillumination mode. For example it is possible for the concealed information to be read out by means of a laser, insofar as the laser beam is directed on to the micro-optical structure and the light reflected or transmitted by the micro-optical structure is detected by means of a sensor and evaluated. It is further possible for the laser light which is reflected or transmitted by the micro-optical structure to be projected on to a screen and evaluated by an observer.

The micro-optical structure can have pixel-form sub-regions of differing depths, the depth of the pixel-form sub-regions encoding the concealed information.

It can be provided that the micro-optical structure is in the form of a computer-generated holographic structure with a plurality of optical elements of differing height.

It can further be provided that the pixel depth<1.5 μm. Preferably between 8 and 256 different pixel depths can be provided.

An advantageous configuration provides that the pixels are of a cross-sectional area of about 1 μm×1 μm. It can be provided that the pixels have side lengths of between 0.4 μm and 4 μm.

If the above-described micro-optical structure is arranged over a window of a carrier substrate or in a transparent region of a carrier substrate the concealed information can be read out by way of example using laser light in the transillumination mode. In that case the laser beam passes through the micro-optical structure and an image of the micro-optical structure can be produced on a screen. The image can be a piece of text such as for example ‘OK’ or an image or the like such as for example the drawing of an eagle. By way of example a laser pointer can be used as the laser light source.

The depth of the above-mentioned pixels from which the micro-optical structure is formed can be determined by the following relationship:

$$d ( x , y ) = \frac{Φ ( x , y ) \cdot λ}{( ( N - 1 / N ) ) 2 π ( {n}_{1} - {n}_{0} )}$$

In that equation N denotes the number of the different pixel depths which for a so-called Kinoform is typically N=64. If a red laser pointer involving a wavelength λ=635 nm is used, the maximum depth d which is required for a phase shift angle Φ=2 π and a lacquer layer involving a refractive index n₁=1.5 is calculated as follows:

$$d ( x , y ) = \frac{2 π \cdot 635}{( 63 / 64 ) 2 π ( 1.5 - 1.0 )} = 1290 nm$$

If in contrast the described micro-optical structure is applied to a non-transparent substrate such as paper then the laser beam is reflected by the surface of the micro-optical structure and the image can be caught for example on a transparent screen arranged in front of the micro-optical structure, for example on a matt glass screen. The dimensional equation now reads as follows:

$$d ( x , y ) = \frac{Φ ( x , y ) \cdot λ}{( ( N - 1 / N ) ) 2 π \cdot 2 {n}_{0}}$$

If a red laser pointer involving a wavelength λ=635 nm is used, the maximum depth d which is required for a phase shift angle Φ=2 π in air involving a refractive index n₀=1 is calculated as follows:

$$d ( x , y ) = \frac{2 π \cdot 635}{( 63 / 64 ) 2 π \cdot 2 \cdot 1.0} = 323 nm$$

In that respect the image is to be considered from the ‘air side’ of the surface relief. The image can again be a text such as for example ‘OK’ or an image or the like such as for example the drawing of an eagle. For the purposes of improving the visibility of the concealed image which is projected in a reflection mode, a material with a high refractive index or a uniformly reflecting material should be used for the micro-optical structure.

It can be provided that the optical elements of the micro-optical structures are formed from an optical lacquer.

In an advantageous configuration it can be provided that the optical lacquer is a highly refractive optical lacquer. As already stated a high refractive index can improve the reflection capability of the lacquer.

It can further be provided that the optical lacquer has a refractive index>1.9.

In order to achieve a high refractive index the optical lacquer used can be a photopolymer which is applied in the above-mentioned intaglio printing procedure.

An advantageous configuration provides that the optical lacquer is doped with nanoparticles. It can also be provided that the optical lacquer is doped with color flakes. As a result a reflecting material is obtained from the optical lacquer. The nanoparticles contain metals in crystal form or metal salts in colloidal form, for example CdS. For example, the incorporation of PbS into a polymer matrix can raise the value of the refractive index to between 2.5 and 3.0. Nano-composite materials of polymers and gold nanoparticles have already been implemented with real components with such a low refractive index as 0.96.

Equally the micro-optical structure can be an OVD such as a hologram which presents the letters ‘AB’ and applied to or impressed into the surface of the multi-layer body by intaglio printing. The surface relief of the intaglio printing plate can be produced for example by 2D or 3D holography or by using a dot matrix machine. If the surface relief of the multi-layer body is a surface relief of non-doped plastic material, which is exposed to the air, the reflection capability of the OVD can be less brilliant than when HRI material or metal is used, as is usual, but the optical effects are present, even if attenuated. The brilliance of the OVD can be enhanced by the above-described doping of the polymer in which the surface relief is shaped.

It can be provided that the first layer of the multi-layer body, which layer has the micro-optical structures, is coated with a protective layer. That protective layer can be typically applied by means of screen printing. It can also be provided that it involves a low-refraction protection layer.

In an advantageous configuration it can be provided that the protection layer has a refractive index<1.5. As already stated hereinbefore the combination of a low-refraction protection layer with a high-refraction micro-optical structure or a micro-optical structure with an HRI surface produce particularly good reflection at the micro-optical structure.

As already stated hereinbefore by way of example a non-transparent security document can have one or more windows. It can then be provided that the multi-layer body is at least partially arranged over a window in the security document. The security document can be for example a window banknote. The security document can now have the following security features which are all transferred in one manufacturing step from the intaglio printing plate on to the security document and/or the multi-layer body:
security features with concealed information,
OVDs such as for example holograms,
micro-lens arrays for the production of tilting images (nimble image effect),
tactile elements,
arrays of cylindrical lenses for the production of a one-dimensional moiré effect or ‘scrambled indicia’,
retroreflectors,
Fresnel lenses, for example in the form of a magnifying glass,
flip elements, for example a change from currency information to value information when the security document is tilted, and
surface reliefs.

The invention is described by way of example by means of a number of embodiments with reference to the accompanying drawings in which:

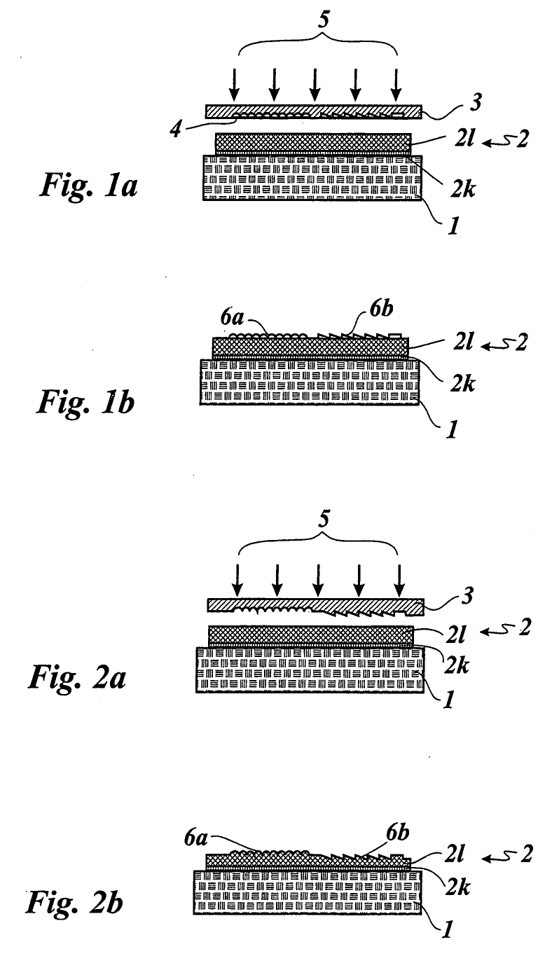

FIGS. 1a and 1b show diagrammatic views of process steps of a first embodiment of the process according to the invention,

FIGS. 2a and 2b show diagrammatic views of process steps of a second embodiment of the process according to the invention,

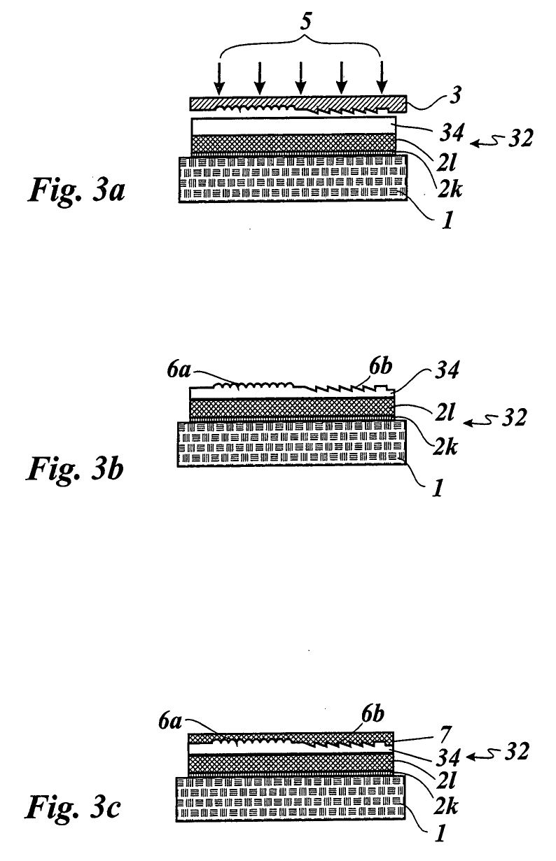

FIGS. 3a through 3c show diagrammatic views of process steps of a third embodiment of the process according to the invention,

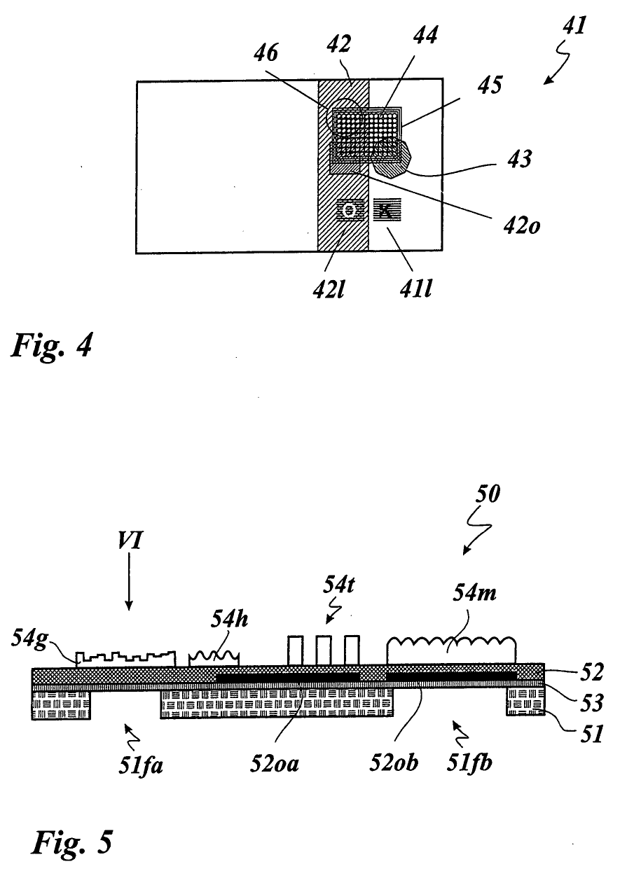

FIG. 4 shows a first example of use of the process according to the invention, and

FIG. 5 shows a second example of use of the process according to the invention.

FIG. 1a shows a carrier substrate 1 which in the illustrated embodiment by way of example is a banknote to which there is applied a multi-layer body 2 which is formed from an adhesive layer 2k and a lamination layer 21 and which is applied for example as part of the transfer layer of a hot stamping film to the carrier substrate 1. The multi-layer body 2 is in the form of a transparent multi-layer body 2 so that the multi-layer body 2 exposes a view on to the carrier substrate 1 arranged beneath it. Applied to the top side of the lamination layer 21 that is remote from the carrier substrate 1, by means of an intaglio printing plate 3, is an optical lacquer 4 which is introduced into recesses in the intaglio printing plate 3. The intaglio printing plate 3 is moved in the direction of the arrows 5 under a high pressing force against a counter-pressure plate disposed behind the carrier substrate, and is brought into contact with the lamination layer 2l, in which case the optical lacquer 4 introduced into the recesses in the intaglio printing plate 3 is released from the recesses and adheres to the top side of the lamination layer 2l. Micro-optical structures 6a and 6b are formed in that way (see FIG. 1b). The optical lacquer 4 has a refractive index of about 1.5 because the micro-optical structures 6a and 6b formed by the lacquer adjoin air.

The micro-optical structure 6a is a micro-lens array while the micro-optical structure 6b is an asymmetrical relief structure, for example a blaze grating. The micro-lens array can be provided in order to optically enlarge alphanumeric characters or an image representation printed on to the carrier substrate. The blaze grating can be provided in order to produce an interesting and attractive optical effect. The boundary contours of the blaze grating can be for example in the form of a logo or an alphanumeric character.

The intaglio printing plate 3 can be a body in plate form or a cylindrical body or a curved plate arranged on a printing cylinder. It can be provided that disposed on a printing cylinder or the like are further intaglio printing plates which for example in register relationship with the micro-optical structures 6a and 6b apply to the lamination layer 2 ink layers which for example can form a background pattern which is partially or completely covered by the micro-optical structures 6a and 6b.

FIGS. 2a and 2b now show a second embodiment by way of example of the process according to the invention.

FIG. 2a shows the multi-layer body 2 of FIG. 1a, which is applied to the carrier substrate 2. The multi-layer body 2 has the adhesive layer 2k and the lamination layer 21. The intaglio printing plate 3 is now used as an embossing tool, with which the micro-optical structures 6a and 6b are shaped into the lamination layer 21 (see FIG. 2b), under the pressing force 5. The micro-optical structures 6a and 6b can at the same time form a tactily perceptible security feature.

FIGS. 3a through 3c now show a third embodiment by way of example of the process according to the invention.

FIG. 3a shows a multi-layer body 32 applied to the carrier substrate 1. The multi-layer body 32, like the multi-layer body 2, comprises the adhesive layer 2k and the lamination layer 2l, with an optical lacquer layer 34 being applied to the side of the lamination layer 2l, that is remote from the adhesive layer. The optical structures 6a and 6b (see FIG. 3b) are shaped into the optical lacquer layer 34 by means of the intaglio printing plate 3, under the pressing force 5.

FIG. 3c now shows in the third step in the process the multi-layer body 32 with a protection layer 7 applied to the surface of the lacquer layer 34. The protection layer 7 has a low refractive index, for example a refractive index<1.5, preferably with a refractive index 1. In a preferred embodiment the protection layer 7 is a normal cover lacquer which has a refractive index of about 1.5 and which is applied using a screen printing process. In that case the optical lacquer layer 34 advantageously has a high refractive index, for example >1.9. It can be doped to produce the high refractive index, for example using nanoparticles. The protection layer 7 enhances the long-term stability of the micro-optical structures 6a and 6b shaped in the lacquer layer 34 and protects them from soiling and/or wear.

FIG. 4 now shows an example of use of the process according to the invention.

On its front side a banknote 41 carries a film strip 42 which has an OVD 42o and a latent image 42l. In. this embodiment the latent image 42l is formed from mutually nested blaze gratings which afford a tilting image. A further latent image 41l is in the form of a colored printed image and is applied by printing to the surface of the banknote 41, which is not covered by the film strip 42. In the embodiment illustrated in FIG. 4 the latent images 41l and 42l are arranged in mutually spaced aligned relationship. The latent image 42l presents the letter ‘O’ and the latent image 41l presents the letter ‘K’. The latent images are only visible at a predetermined viewing angle. From all other viewing directions they are invisible, that is to say latent.

Beside the OVD 42o a further OVD 43 is applied to the surface of the banknote 41 which is not covered by the film strip 42.

The banknote 41 further has a micro-lens array 44 which is arranged over an image region 45 in register relationship. The OVDs 42o and 43 are also arranged in register relationship with the micro-lens array 44 and are partially covered over by the micro-lens array 44.

Arranging the micro-lens array 44, the image region 45 as well as the OVDs 42o and 43 in register relationship is possible by the use of the process according to the invention as described hereinbefore, under mass production conditions, because all the elements referred to are applied to the banknote 41 in an intaglio printing process on one installation.

Instead of the banknote it is also possible to provide any other security document.

The banknote 41 can optionally have a window 46 which projects at least region-wise into the region of the micro-lens array.

FIG. 5 now shows a second example of use of the process according to the invention.

A window banknote 50 which is shown as a diagrammatic view in section comprises a carrier substrate 51 having window-like openings 51fa and 51fb. The carrier substrate 51 can be for example a paper which is suitable for banknotes or a plastic film. A lamination layer 52 has optically variable elements (OVD) 52oa and 52ob which for example can be a KINEGRAM®. The KINEGRAM® can be completely metallised, demetallised or implemented with a metallisation determined by the aspect ratio of the surface relief, it can have an HRI layer or it can be in the form of a multi-layer, or it can be in the form of a system with color change effects, and a (cross-linked) liquid crystal layer can be integrated into the system. The OVD 52ob is arranged in the window opening 51fb and can therefore be viewed both in an incident illumination mode and also in a transillumination mode. The OVD 52oa is arranged outside the window openings 51fa and 51fb and can therefore be viewed only in an incident illumination mode from the front side of the window banknote 50. The lamination layer 52 can be in the form of a transparent film or in the form of a semi-transparent film, for example a colored film.

On its underside the lamination layer 52 has an adhesive layer 53 by means of which it is joined to the carrier substrate 51. The adhesive layer can be a hot adhesive.

The top side of the lamination layer 52 is now printed upon with different security elements. These involve a computer-generated hologram 54g provided with concealed information; a hologram 54h which for example can reproduce alphanumeric characters such as a value print in a highly effective manner; tactile features 54t which for example can provide tactile information about the value of the banknote; and a micro-lens array 54m which in this embodiment is applied in register relationship with the OVD 52ob arranged in the window opening 51fb. When the front side of the window banknote 50 is viewed the micro-lens array 54m produces an optically enlarged reproduction of the optical information stored in the OVD 52ob. In contrast, when viewing the rear side of the window banknote 50, the micro-lens array 54m is optically not effective so that the optical information stored in the OVD 52ob appears in its natural size. As already described hereinbefore the holograms 54g and 54h, the tactile feature 54t and the micro-lens array 54m are applied using intaglio printing in one working step and are therefore arranged in strict register relationship with each other. If therefore the micro-lens array 54m is applied in register relationship with the OVD 52ob, then the other elements which are applied by printing are also in register relationship with the OVD 52ob and all further elements introduced into the lamination layer in register relationship such as the OVD 52oa.

The computer-generated hologram 54g has pixel regions of differing depth. The maximum pixel depth in the embodiment shown in FIG. 5 is 1 μm, and the pixels are of a size of 1 μm×1 μm. The concealed information is encoded in the pixel depth which causes a change in the phase position of the incident light. There can be provided for example between 8 and 256 different depths, that is to say, depending on the respective number of different depths in a pixel, it is possible to store items of information of between 8 bits and 256 bits.

1. A process for the production of a multi-layer body comprising a first layer which is formed from a micro-optical structures and which at least partially covers over one or more further layers having image regions and/or effect regions which produce an optical effect,
wherein the micro-optical structures are applied by means of intaglio printing to the layer under the first layer or are introduced into the first layer.

2. A process as set forth in claim 1 wherein the micro-optical structures and also the image regions and/or effect regions are applied by means of intaglio printing.

3. A process as set forth in claim 2, wherein the micro-optical structures as well as the image regions and/or effect regions are applied with the same printing plate and/or the same printing machine in register relationship.

4. A process as set forth in claim 1, wherein, for applying the micro-optical structures, an optical lacquer is transferred by means of intaglio printing on to the further layers.

5. A process as set forth in claim 1, wherein a layer formed from the optical lacquer is applied to the further layers and then the micro-optical structures are shaped in the layer formed from the optical lacquer by means of pressing an intaglio printing plate thereon.

6. A process as set forth in claim 5, wherein the layer formed from the optical lacquer is transferred on to the further layers by means of a transfer film.

7. A process as set forth in claim 5, wherein the intaglio printing plate is heated to between 90° C. and 100° C.

8. A process as set forth in claim 5, wherein lacquer, in particular colored lacquer, is applied to the intaglio printing plate in a first region and no lacquer is applied in a second region and then the micro-optical structures are shaped in the second region by pressing the intaglio printing plate thereon.

9. A multi-layer body comprising a first layer which is formed from micro-optical structures and which at least partially covers over one or more further layers having image regions and/or effect regions which produce an optical effect,
wherein the micro-optical structures are applied by means of intaglio printing to the layer under the first layer or are introduced into the first layer.

10. A multi-layer body as set forth in claim 9 wherein the micro-optical structures are formed from hemispherical or pyramid-shaped or prismatic or cylindrical optical elements with a flat base surface, wherein the flat base surfaces of said optical elements define at least one plane which is towards a further layer and which forms the interface in relation to the further layer or layers on which the optical elements are arranged.

11. A multi-layer body as set forth in claim 9, wherein the micro-optical structures involve a period spacing of between 100 μm and 0.3 μm.

12. A multi-layer body as set forth in claim 11 wherein the micro-optical structures involve a period spacing of between 20 μm and 2 μm.

13. A multi-layer body as set forth in claim 9, wherein the micro-optical structures are of a depth of 50 μm to 1 μm.

14. A multi-layer body as set forth in claim 9, wherein the micro-optical structure contains concealed information.

15. A multi-layer body as set forth in claim 14, wherein the concealed information can be read out in the incident illumination mode and/or in the transillumination mode.

16. A multi-layer body as set forth in claim 14 wherein the micro-optical structure has pixel-form sub-regions of differing depths, wherein the depth of the pixel-form sub-regions encodes the concealed information.

17. A multi-layer body as set forth in claim 9, wherein the micro-optical structure is in the form of a computer-generated holographic structure having a plurality of optical elements of differing heights.

18. A multi-layer body as set forth in claim 17 wherein the depth of the pixel-form sub-regions is<1.5 μm.

19. A multi-layer body as set forth in claim 16, wherein there are provided between 8 and 256 different depths in respect of the pixel-form sub-regions.

20. A multi-layer body as set forth in claim 16, wherein the pixel-form sub-regions have side lengths of between 0.4 μm and 4 μm.

21. A multi-layer body as set forth in claim 9, wherein the optical elements are formed from an optical lacquer.

22. A multi-layer body as set forth in claim 21, wherein the optical lacquer is a high-refraction optical lacquer.

23. A multi-layer body as set forth in claim 22, wherein the optical lacquer has a refractive index>1.9.

24. A multi-layer body as set forth in claim 21, wherein the optical lacquer is doped with nanoparticles.

25. A multi-layer body as set forth in claim 24, wherein the nanoparticles are metals and/or metal alloys and/or metal salts.

26. A multi-layer body as set forth in claim 24, wherein the nanoparticles are colored particles.

27. A multi-layer body as set forth in claim 9, wherein the first layer having the micro-optical structures is coated with a protection layer.

28. A multi-layer body as set forth in claim 27, wherein said protection layer is a low-refraction protection layer.

29. A multi-layer body as set forth in claim 27, wherein the protection layer has a refractive index<1.5.

30. A security document comprising a multiple-layer body as set forth in claim 9.

31. A security document as set forth in claim 30, wherein the multi-layer body is arranged at least partially over a windown in the security document.
